(19) United States
(12) Patent Application Publication
(10) Pub. No.: US 2006/0192930 A1
(43) Pub. Date: Aug. 31, 2006

(54) EXPOSURE APPARATUS

(75) Inventors: AKIKO IIMURA, Utsunomiya-shi (JP); Sunao Mori, Utsunomiya-shi (JP); Noriyasu Hasegawa, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/276,382

(22) Filed: Feb. 27, 2006

(30) Foreign Application Priority Data
Feb. 28, 2005 (JP) 2005-054814
Feb. 2, 2006 (JP) 2006-026249

(51) Int. Cl. G03B 27/42

(52) U.S. Cl. 355/53; 355/30

(57) ABSTRACT

An exposure apparatus includes a projection optical system for projecting a pattern of a reticle onto an object to be exposed, via a liquid that is filled in a space between a final optical element in the projection optical system and the object, and a liquid-holding member provided around the object and having a surface that is as high as a surface of the object, the liquid-holding member provided for retaining the liquid, wherein the surface of the liquid-holding member is processed so that a first contact angle between the liquid and the surface of the object is equal to or smaller than a second contact angle between the liquid and the surface of the liquid-holding member.

### BACKGROUND OF THE INVENTION

The present invention relates generally to an exposure apparatus, and more particularly to an exposure apparatus that fills a space between a final optical element in an immersion projection optical system and an object with a liquid and exposes the object via the projection optical system and the liquid.

A projection exposure apparatus has been conventionally used to transfer a circuit pattern on a reticle (or a mask), via a projection optical system, onto a wafer, etc., and high-quality exposure at a high resolution has recently been increasingly demanded.

The immersion exposure has attracted attention as one means that satisfies this demand. See, for example, U.S. Pat. No. 5,121,256. The immersion exposure promotes a higher numerical aperture (“NA”) of the projection optical system by replacing a medium (typically air) at the wafer side of the projection optical system with a liquid. The projection optical system has an NA=n·sin θ, where n is a refractive index of the medium, and the NA increases when the medium has a refractive index higher than the air's refractive index, i.e., n>1. As a result, the resolution R(R=k₁(λ/NA)) of the exposure apparatus defined by a process constant k₁ and a light source wavelength λ becomes small.

For the immersion exposure, a local fill method that locally fills a space between a final surface of the projection optical system and a surface of the wafer with the liquid has been proposed. See, for example, International Publication No. WO99/49504. If the wafer is exposed moving the wafer to the projection optical system by the local fill method, the liquid remains in the projection optical system and air bubbles, and and turbulence occur. The turbulence applies a pressure to the final surface of the projection optical system and causes an aberration by a minute deformation. Then, an exposure apparatus that is given a surface treatment to adjust an affinity with the liquid to a contact portion with the liquid has been proposed to prevent deterioration of transferring performance. See, for example, Japanese Patent Application, Publication No. 2004-205698.

Moreover, an exposure apparatus that provides a liquid-holding member, which has a surface that is as high as the surface of the wafer, around the wafer, has been proposed so that the liquid does not overflow when a shot of a wafer edge is exposed. See, for example, Japanese Patent Application, Publication No. 2004-289128.

However, in the local fill method, if the wafer is exposed by moving the wafer and the liquid-holding member provided around the wafer, the liquid remains in the liquid-holding member. Therefore, the air bubbles and turbulence occur when the shot of the wafer edge is exposed. As a result, the transferring performance deteriorates, and high-quality exposure cannot be provided.

### BRIEF SUMMARY OF THE INVENTION

Accordingly, the present invention is directed to an exposure apparatus that achieves a high resolution and high-quality exposure.

An exposure apparatus of one aspect of the present invention includes a projection optical system for projecting a pattern of a reticle onto an object to be exposed, via a liquid that is filled in a space between a final optical element in the projection optical system and the object, and a liquid-holding member provided around the object and having a surface that is as high as a surface of the object, the liquid-holding member provided for retaining the liquid, wherein the surface of the liquid-holding member is processed so that a first contact angle between the liquid and the surface of the object is equal to or smaller than a second contact angle between the liquid and the surface of the liquid-holding member.

An exposure apparatus according to another aspect of the present invention includes a projection optical system for projecting a pattern of a reticle onto an object to be exposed, via a liquid that is filled in a space between a final optical element in the projection optical system and the object, and a liquid-holding member provided around the object and having a surface that is as high as a surface of the object, the liquid-holding member provided for retaining the liquid, wherein the surface of the liquid-holding member is processed so that a first receding contact angle between the liquid and the surface of the object is equal to or less than a second receding contact angle between the liquid and the surface of the liquid-holding member.

A device fabricating method according to still another aspect of the present invention includes the steps of exposing an object to be exposed using the above exposure apparatus, and performing a development process for the object exposed.

Other objects and further features of the present invention will become readily apparent from the following description of the preferred embodiments with reference to the accompanying drawings.

### BRIEF DESCRIPTION OF THE DRAWINGS

FIG. 1 is a schematic block diagram of an exposure apparatus as one aspect according to the present invention.

FIG. 2 is a schematic plan view of a wafer and a liquid-holding board of the exposure apparatus shown in FIG. 1.

FIG. 3 is a partially enlarged view of an example of the exposure apparatus shown in FIG. 1.

FIG. 4 is a flowchart for explaining a method of fabricating devices (e.g., semiconductor chips, such as ICs, LSIs, and the like, LCDs, CCDs, etc.).

FIG. 5 is a detailed flowchart of a wafer process in Step 4 of FIG. 4.

FIG. 6 is an enlarged sectional view of near a lens (final optical element) in a projection optical system shown in FIG. 1.

FIGS. 7A and 7B are enlarged sectional views of a periphery part of a nozzle port of a recovery nozzle shown in FIG. 6 by reference A.

FIGS. 8A and 8B are enlarged sectional views of a periphery part of a nozzle port of a recovery nozzle shown in FIG. 6 by reference A.

FIGS. 9A and 9B are enlarged sectional views of a periphery part of a nozzle port of a recovery nozzle shown in FIG. 6 by reference A.

FIG. 10 is a schematic sectional view that shows a shape change of a liquid when a wafer moves.

FIGS. 11A and 11B are enlarged sectional views of a periphery part of a nozzle port of a recovery nozzle shown in FIG. 6 by reference A.

FIGS. 12A and 12B are enlarged sectional views of a periphery part of a nozzle port of a recovery nozzle shown in FIG. 6 by reference A.

### DETAILED DESCRIPTION OF THE PREFERRED EMBODIMENTS

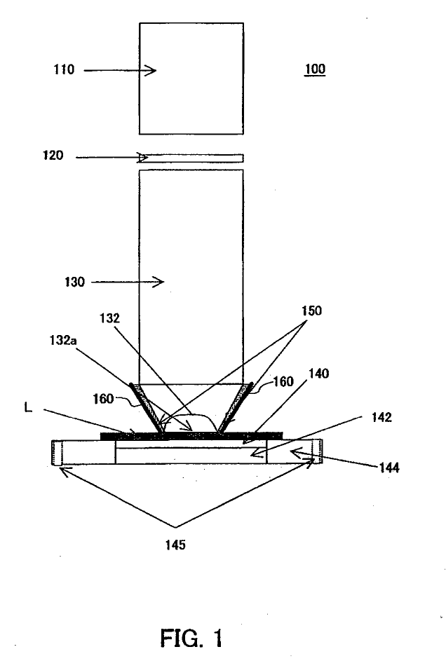

With reference to the accompanying drawings, a description will be given of an exposure apparatus according to one aspect of the present invention. Here, FIG. 1 is a schematic block diagram of an exposure apparatus 100.

The exposure apparatus 100 includes, as shown in FIG. 1, an illumination optical system 110, a reticle stage that mounts a reticle (mask) 120, a projection optical system 130, a wafer stage 142 that mounts a wafer 140, and a liquid supply and recovery mechanism 150.

The exposure apparatus 100 is an immersion type exposure apparatus that partially or entirely immerges a final surface of a lens (final optical element), which is closest to the wafer 140, in the projection optical system 130, and exposes a pattern of the reticle 120 onto the wafer 140 via a liquid L. While the exposure apparatus 100 of the present invention is a projection exposure apparatus in a step-and-scan manner, the present invention is applicable to a step-and-repeat manner and other exposure methods.

The illumination optical system 110 is an optical system that illuminates the reticle 120 using exposure light from a light source section (not shown). The light source section includes, in the instant embodiment, a laser and a beam shaping system. The laser can use a pulsed laser, such as an ArF excimer laser with a wavelength of approximately 193 nm, a KrF excimer laser with a wavelength of approximately 248 nm, an F₂ laser with a wavelength of approximately 157 nm, etc. The beam shaping system can use, for example, a beam expander, etc., with a plurality of cylindrical lenses.

The illumination optical system 110 includes, for example, a condenser optical system, an optical integrator, an aperture stop, a condenser lens, a masking blade, and an imaging lens. The illumination optical system 110 can realize various illumination modes, such as conventional illumination, annular illumination, quadrupole illumination, etc.

The reticle 120 has a circuit pattern or a pattern to be transferred, and is supported and driven by the reticle stage (not shown). Diffracted light emitted from the reticle 120 passes the projection optical system 130, and then is projected onto the wafer 140. The wafer 140 is an object to be exposed, and a photoresist is coated thereon. The reticle 120 and the wafer 140 are located in an optically conjugate relationship. The exposure apparatus 100 is an exposure apparatus in a step-and-scan manner, and, therefore, scans the reticle 120 and the wafer 140 to transfer the pattern of the reticle 120 onto the wafer. When it is an exposure apparatus in the step-and-repeat manner (in other words, a stepper), the reticle 120 and the wafer 140 are kept stationary for exposure.

The reticle stage supports the reticle 120, and is connected to a moving mechanism (not shown). The moving mechanism is made up of a linear motor, and the like, and drives the reticle stage in X and Y directions, thus, moving the reticle 120.

The projection optical system 130 serves to image the diffracted light that has been generated by the pattern of the reticle 120 onto the wafer 140. The projection optical system 130 includes, in the instant embodiment, a planoconvex lens having a power as a lens 132, which is closest to the wafer 140. However, the present invention does not limit the planoconvex lens to the final optical element in the projection optical system 130, and may be other lenses, such as a meniscus lens. The planoconvex lens 132 has an under surface (final surface) 132a with a flat portion, and prevents turbulence of the liquid L and mix of air bubbles by it at scanning. The final surface 132a of the planoconvex lens 132 has a coating to prevent an influence from the liquid L.

The wafer 140 is replaced with a liquid crystal plate and another object to be exposed in another embodiment. The photoresist is coated on the surface of the wafer 140. The wafer 140 is supported by the wafer stage 142 via a wafer chuck. The wafer stage 142 may use any structure known in the art, and preferably utilizes six-axis coax. For example, the wafer stage 142 uses a linear motor to move the wafer 170 in the X, Y and Z directions.

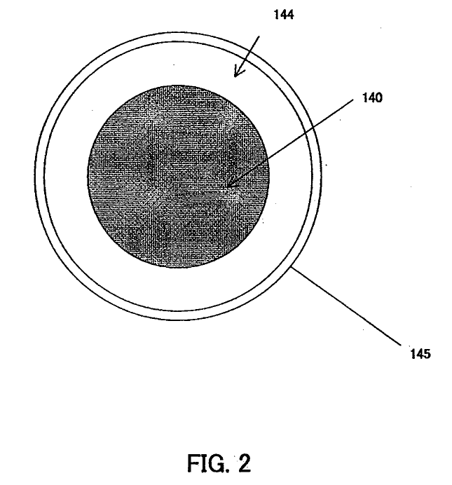

FIG. 2 is a schematic plan view of the wafer 140 and a liquid-holding member (or liquid-holding board) 144. The liquid-holding board 144 is provided around the wafer 140 mounted on the wafer stage 142, as shown in FIG. 2. The liquid-holding board 144 has a surface that is as high as the surface of the wafer 140, and retains the liquid L. When exposure is completed and the wafer 140 is exchanged, the liquid L held between the lens 132 and the wafer 140 moves to the liquid-holding board 144 from the wafer 140 according to movement of the wafer 140. The liquid-holding board 144 includes a recovery port (slit or porous) 145. The moved liquid L can be exhausted from the recovery port 145 by aspirating the recovery port 145 from the under surface of the liquid-holding board 144.

The liquid supply and recovery mechanism 150 supplies the liquid L between the lens 132 in the projection optical system 130 and the wafer 140 and recovers the supplied liquid L.

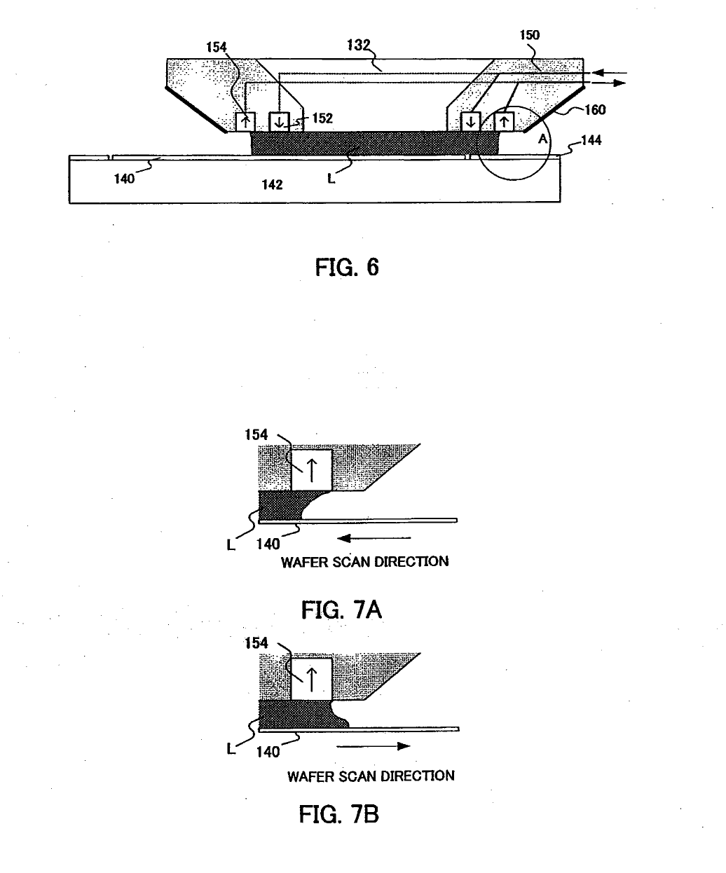

FIG. 6 is an enlarged sectional view of near the lens 132 in the projection optical system 130. FIG. 6 shows a situation that the liquid L supplied on the wafer 140 and the wafer stage 142 is stopped. A supply nozzle 152 and a recovery nozzle 154 are provided on a circumference so that a periphery of the lens 132 is surrounded. The nozzle port of the supply nozzle 152 or the recovery nozzle 154 may be a mere opening. However, a porous board having a plurality of minute pores, a fiber type or a powder type metal material, or a porous member sintered inorganic material is suitable for the nozzle port of the supply nozzle 152 or the recovery nozzle 154 to decrease a positional non-uniformity of a supply and recovery amount of the liquid L and to prevent a liquid drop. Materials used for these are a stainless steel, a nickel, an alumina, and a quartz glass, in consideration of an elution to the liquid L. Moreover, the under surface in the nozzle port of the supply nozzle 152 or the recovery nozzle 154 (for example, a liquid contacting surface of the porous member) is preferably formed so that a step between a liquid contacting surface of a retainer member to retain the nozzle port and the under surface in the nozzle port is not generated. Thereby, an involvement of the air bubbles to the liquid L occurring by the step can be decreased.

Thus, the liquid supply and recovery mechanism 150 fills only a space between the projection optical system 130 and the wafer 140 with the liquid L, and is used for the local fill method. A periphery of the liquid L is retained by an air curtain (not shown).

The liquid L may be a good transmittance to the wavelength of the exposure light, and have an almost same refractive index as a lens material, such as a quartz and a fluorite. Moreover, the liquid is selected from materials that do not contaminate the projection optical system 130 and matches the resist process. The liquid L is, for example, a pure water, a function water, a liquid fluoride (for example, fluorocarbon), or a high refractive index member, and selected according to the resist coated on the wafer 140 and the wavelength of the exposure light. The high refractive index member includes, for example, an alkaline earth oxide such as MgO, CaO, SrO and BaO, an inorganic acid such as H₃PO₄, a water added salt, an alcohol derivative, such as glycerol, and a hydrocarbon organic liquid.

The liquid L is preferably fully removed of a dissolved gas by a degasifier beforehand. This liquid L suppresses the generation of the air bubbles, and immediately absorbs the air bubbles into the liquid even if the air bubbles are generated. For example, nitrogen and oxygen contained in an atmosphere are targeted, if 80% or more of a dissolvable gas amount into the liquid L, the generation of the air bubbles can be fully suppressed. The exposure apparatus 1 may include the degasifier (not shown), and supply the liquid L while removing the dissolved gas of the liquid L. For example, a vacuum degasifier that flows the liquid into one side separated by a gas transmission film, makes the other side a vacuum, and exhausts the dissolved gas of the liquid L to the vacuum through the film is suitable as the degasifier.

The liquid supply and recovery mechanism 150 includes the supply nozzle 152 and the recovery nozzle 154 that contacts with the liquid L. The supply nozzle 152 is a part of a liquid supply system that includes a tank that stocks the liquid L, a compressor that flows the liquid LW, and a flow rate controller that controls a supply flow rate of the liquid L. The recovery nozzle 154 is a part of a liquid recovery system that includes a tank that temporarily stocks the recovered liquid L, a suction apparatus that absorbs the liquid L, and a flow rate controller that controls a recovery flow rate of the liquid L. In the instant embodiment, the liquid supply and recovery mechanism 150 is provided with a lens barrel of the projection optical system 130. However, the liquid supply and recovery mechanism 150 may be separated from the projection optical system 130.

### First Embodiment

The wafer 140 moves and the liquid L is deformed, by moving the wafer stage 142. In FIG. 1, the instant embodiment uses a pure water for the liquid L, and uses a silicon substrate for the wafer 140. The instant embodiment prepares a material given an electroless plating to a stainless steel, an aluminum and a casting, and a material given a polytetrafluoroethylene (PTFE) coating to a surface. A contact angle to the wafer is 55° by the stainless steel, 55° by the aluminum, 50° by the electroless KN plating, and 108° by the PTFE coat.

A contact angle of the silicon substrate to the wafer is so small that it is clean, and is less than 10° just after a PCA cleaning or an UV/O₃ cleaning. However, when the silicon substrate is actually exposed, it has passed through the resist coating process, and the contact angle of the resist surface to the water changes by the process and resist material. The instant embodiment uses a resist material that has a contact angle to the water of 70° to 80° in the process.

The projection optical system 130 contacts with the liquid L in a liquid contacting portion that consists of a part of the liquid supply and recovery mechanism 150 (a surface almost parallel to the surface of the wafer 140) and the lens (final optical element) 132. The surface parallel to the wafer 140 in the liquid supply and recovery mechanism 150 includes the surface of the nozzle port of the supply nozzle 152 and the recovery nozzle 154, and the surface of the retainer member that retains these nozzle ports. The nozzle port uses a material given an electroless plating to a stainless steel, an aluminum and a casting. Moreover, a material of the lens 132 uses the quartz. These contact angles to the water are so small that these are clean, and are less than 10° just after a suitable cleaning such as the PCA cleaning and the UV/O₃ cleaning. The contact angle of these liquid contacting members maintains less than 60° in the exposure process of the instant embodiment.

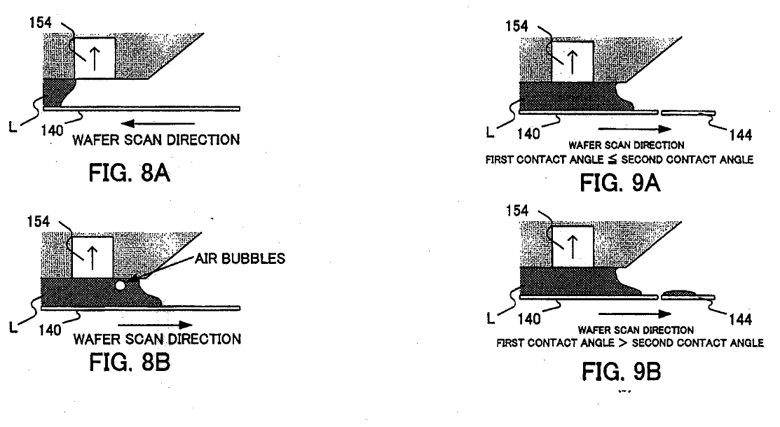

FIGS. 7A to 8B are enlarged sectional views of a periphery part of the nozzle port of the recovery nozzle 154 shown in FIG. 6 by reference A. FIGS. 7A and 8A show a shape change of the liquid L when the wafer stage 142 is moved in a left direction. FIGS. 7B and 8B show the shape change of the liquid L when the wafer stage 142 is moved in a right direction. Moreover, FIG. 7B shows the shape change of the liquid L when a contact angle of the liquid L to a part of the liquid supply and recovery mechanism 150 or the lens 132 (a third contact angle) is equal to or smaller than a contact angle of the liquid L to the wafer 140 (a first contact angle). FIG. 8B shows the shape change of the liquid L when the third contact angle is equal to or larger than the first contact angle.

Generally, in a relationship between an adhesion between the liquid and members that contact with the liquid and the contact angle, the adhesion is large when the contact angle is smaller.

When the third contact angle is equal to or smaller than the first contact angle, the shape of the liquid L changes from that shown in FIG. 7A to that shown in FIG. 7B by moving the wafer stage 142 in the right direction after moving in the left direction. Because the adhesion between a part of the liquid supply and recovery mechanism 150 or the lens 132 and the liquid L to the wafer 140 is large, a movement amount of the liquid L according to the movement of the wafer 140 is small. Therefore, when the wafer stage 142 moves in an opposite direction, a change of an interface of the liquid L is small, and the interface is stabilized.

On the other hand, when the third contact angle is equal to or larger than the first contact angle, the shape of the liquid L changes from that shown in FIG. 8A to that shown in FIG. 8B by moving the wafer stage 142 in the right direction after moving in the left direction. Because the adhesion between a part of the liquid supply and recovery mechanism 150 or the lens 132 and the liquid L to the wafer 140 is small, the movement amount of the liquid L according to the movement of the wafer 140 is large. Therefore, when the wafer stage 142 moves in an opposite direction, the interface of the liquid L is greatly changed and the air bubbles mix into the liquid L.

Thus, if the contact angle of the liquid contacting portion in the projection optical system 130 is equal to or smaller than the contact angle of the liquid contacting portion in the wafer 140, the change of the interface of the liquid L can be controlled and the mix of the air bubbles into the liquid L can be decreased.

Moreover, the adhesion of the liquid L to a part of the liquid supply and recovery mechanism 150 and the lens 132 is equal to or larger than the wafer 140, the movement amount of the liquid L according to the movement of the wafer 140 becomes small. Therefore, while the projection optical system 130 exposes an arbitrary shot on the wafer 140, the liquid cannot dissociate, and remains of the liquid L on another shot can be decreased.

Generally, in the relationship between the adhesion between the liquid and members that contact with the liquid and the contact angle, the adhesion is large when the contact angle is smaller. Therefore, as mentioned above, if the contact angle of the liquid contacting portion in the projection optical system 130 is less than 60° (in other words, lypophilic), remains of the liquid L can be decreased.

Moreover, a fourth contact angle between a side surface 160 that is a periphery part of the liquid supply and recovery mechanism 150 inclined to the surface of the wafer or the liquid-holding board 144 shown in FIG. 1 (periphery part 160 of the liquid contacting portion in the liquid supply and recovery mechanism shown in FIG. 6), and the liquid L is preferably equal to or larger than the third contact angle. Thereby, contact to the liquid L and the side surface of the liquid supply and recovery mechanism 150 can be decreased, and the liquid L contacted with the side surface of the liquid supply and recovery mechanism 150 does not still remain on the side surface.

On the other hand, generally, in the relationship between the adhesion between the liquid and members that contact with the liquid and the contact angle, the adhesion is small when the contact angle is larger. Therefore, as mentioned above, if the fourth contact angle between the liquid L and the side surface 160 of the liquid supply and recovery mechanism 150 is 90° or more, the liquid L cannot further easily remain on the side. In other words, the recovery nozzle 154 of the liquid supply and recovery mechanism 150 can immediately recover the remaining liquid L.

FIGS. 9A and 9B are enlarged sectional views of a periphery part of the nozzle port of the recovery nozzle 154 shown in FIG. 6 by reference A. FIGS. 9A and 9B show a shape change of the liquid L when the wafer stage 142 is moved in the right direction from the situation that the liquid L is supplied between the wafer 140 and the liquid-holding board 144. The contact angle of the liquid L to the wafer 140 is set to the first contact angle, and the contact angle of the liquid L to the liquid-holding board 144 is set to the second contact angle. FIG. 9A shows the shape change of the liquid L when the first contact angle is equal to or smaller than the second contact angle. FIG. 9B shows the shape change of the liquid L when the first contact angle is equal to or larger than the second contact angle.

In FIG. 9A, the adhesion of the liquid L to the liquid-holding board 144 is equal to or smaller than the adhesion of the liquid L to the wafer 140, and the liquid L cannot easily remain in the top surface of the liquid-holding board 144. On the other hand, in FIG. 9B, the adhesion of the liquid L to the liquid-holding board 144 is equal to or larger than the adhesion of the liquid L to the wafer 140, and the liquid L remains in the top surface of the liquid-holding board 144.

Therefore, if the liquid-holding board 144 is a material with a comparatively small contact angle, such as stainless steel, aluminum and electroless KN plating, the liquid L at exposure remains in the liquid-holding board 144 and foams, and a defective exposure is caused at the edge of the wafer 140.

On the other hand, the instant embodiment gives the PTFE coating that adjusts the contact angle to the surface of the liquid-holding board 144 made from stainless steel, aluminum and electroless KN plating. Thereby, the contact angle of the liquid-holding board to the liquid L becomes equal to or larger than the contact angle of the wafer 140 to the liquid L. In other words, a liquid repellency of the liquid-holding board 144 becomes equal to or larger than a liquid repellency of the wafer 140. As a result, the liquid L does not remain in the liquid-holding board 144 and moves with the wafer 140.

In addition, the instant embodiment gives the PTFE coating to a surface, which contacts with the liquid L, of the liquid-holding board 144. However, a fluoride resin, such as a PTFE and a polyperfluoroalkoxyethylene, a copolymer thereof (PFA), and a derivative thereof, and a modified layer of a polyparaxylylene resin (parylene), may be given. The contact angle of a typical PFA material is almost 100°, and is modified within the range of the present invention by adjusting a polymerization and introducing the derivative and a function. Similarly, the polyparaxylylene resin (parylene) is modified within the range of the present invention by adjusting a polymerization and introducing the derivative and a function. Moreover, the surface may be processed by a silane coupling agent such as a silane including a perfluoroalkyle group.

A surface roughness may be adjusted by forming a minute structure of convexo-concave or acicular on the surface of the liquid-holding board 144 given the fluoride resin coating, etc. A material that is easily wet becomes a material that is further easily wet and a material that cannot become easily wet becomes a material that cannot become further easily wet, by forming the minute structure (convexo-concave) on the surface. Therefore, the contact angle of the liquid-holding board 144 can become seemingly large, and the contact angle of a member that forms the liquid supply and recovery mechanism 150 to the liquid L can become seemingly small by forming the minute structure (convexo-concave).

Moreover, the nozzle port may use heat-treated SiO₂ (contact angle is 10°), SiC (contact angle is 57°) or a material that is a heat-treated SiC replaced only the surface by SiO₂. However, in the situation that the periphery part of the wafer 140 is exposed, when a moving velocity of the wafer stage 142 is fast or a long distance of several hundreds of mm or more is moved at the exchange of the wafer 140, and the moving velocity of the wafer stage 142 is fast, the liquid L easily remains in the liquid-holding board 144.

In this case, the second contact angle between the liquid L and the liquid-holding board 144 preferably is 90° or more. Generally, in the relationship between the adhesion between the liquid and members that contact with the liquid, and the contact angle, the adhesion is small when the contact angle is larger. Therefore, the liquid L cannot easily remain in the liquid-holding board 144 by bringing the liquid-holding board 144 to the liquid repellency.

When the liquid L remains in the liquid-holding board 144, the liquid L remaining in the liquid-holding board 144 jumps out an outside of the liquid-holding board 144 according to movement of the wafer stage 142. In this case, the liquid L that has moved to the periphery part of the liquid-holding board 144 can be recovered by using the recovery port 145, and the liquid L diffused near the wafer stage 142 can be decreased.

### Second Embodiment

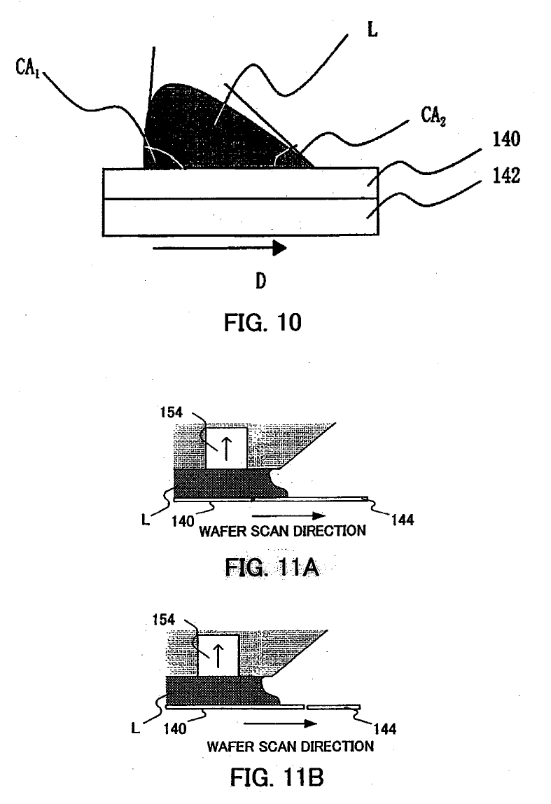

The first embodiment describes the effect by a contact angle difference between the wafer 140 and the liquid-holding board 144. However, even if the contact angle is the same value, the shape change of the liquid L differs because the adhesion differs. FIG. 10 is a schematic sectional view of the shape change of the liquid L when the wafer 140 is moved.

In FIG. 10, the liquid L changes in an opposite direction to the moving direction of the wafer stage 142. Therefore, a dynamic contact angle of the opposite direction to the moving direction D of the wafer stage 142 is an advancing contact angle CA1, and a dynamic contact angle of the same direction to the moving direction D of the wafer stage 142 is a receding contact angle CA2. This dynamic contact angle changes according to the moving velocity of the wafer stage 142.

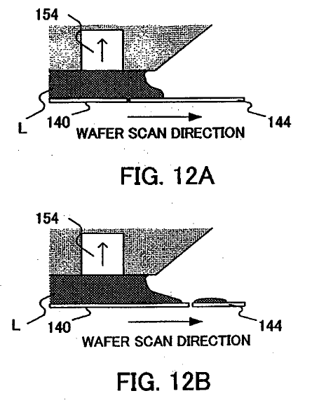

FIGS. 11A to 12B are enlarged sectional views of the periphery part of the nozzle port of the recovery nozzle 154 shown in FIG. 6 by reference A. FIGS. 11A to 12B show the shape change of the liquid L when the wafer stage 142 is moved in the right direction from the situation that the liquid L is supplied between the wafer 140 and the liquid-holding board 144.

In FIGS. 11A to 12B, the wafer 140 uses the same material. However, the receding contact angle of the liquid-holding board 144 in FIGS. 12A and 12B are equal to or smaller than the receding contact angle of the liquid-holding board 144 in FIGS. 11A and 11B.

FIG. 11A shows a situation that a gap between the wafer 140 and the liquid-holding board 144 exists under the liquid L, and FIG. 11B shows a situation that the gap between the wafer 140 and the liquid-holding board 144 passed through under the liquid L.

In FIGS. 11A and 11B, the adhesion of liquid L to the liquid-holding board 144 is equal to or smaller than the adhesion of the liquid L to the wafer 140. Therefore, the liquid L cannot easily remain in the top surface of the liquid-holding board 144. On the other hand, in FIGS. 12A and 12B, the adhesion of the liquid L to the liquid-holding board 144 is equal to or larger than the adhesion of the liquid L to the wafer 140. Therefore, the liquid L remains in the top surface of the liquid-holding board 144.

Thus, if the receding contact angle of the wafer 140 is equal to or smaller than the receding contact angle of the liquid-holding board 144, the liquid L cannot easily remain in the top surface of the liquid-holding board 144.

### Third Embodiment

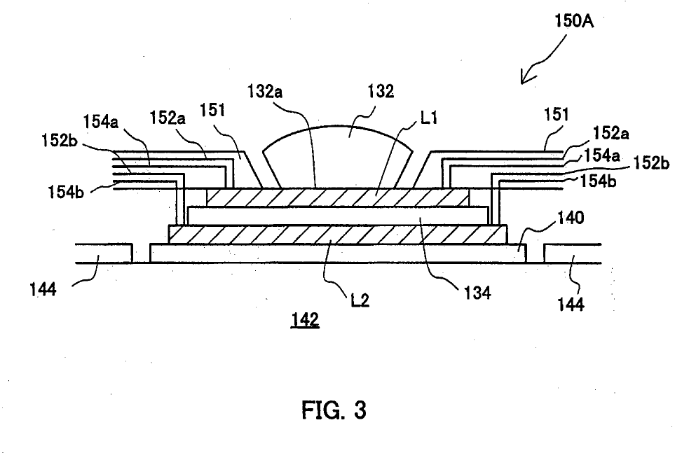

FIG. 3 shows an example of an exposure apparatus 100 that inserts a parallel plate (final optical element) 134 between the lens 132 in the projection optical system 130 and the wafer 140. The parallel plate 134 protects a surface 132a of the lens 132 from the contamination, and has, for example, a circular plate shape. If the parallel plate 134 does not exist, contaminations, such as a PAG agent and acid, melt into the liquid L from the resist coated to the wafer 140 and adhere to the surface 132a, and the deterioration of an optical performance, such as a transmittance decrease of the projection optical system 130, is caused. In this case, the contaminated parallel plate 134 may be exchanged without exchanging the lens 132 in the projection optical system 130. Then, maintenance becomes easy and economical. The parallel plate 134 may be a lens that does not have a power, and is not limited to this. For example, the parallel plate 134 may be an optical element that has a parallel plate shape (for example, a filter), etc. The parallel plate 134 may be coupled to the lens barrel of the projection optical system 130 and may not be coupled to the lens barrel of the projection optical system 130. In other words, the parallel plate 134 may be a part of the projection optical system 130 and may be another member. The parallel plate of the instant embodiment has stopped during exposure.

In the instant embodiment, the liquid L includes a liquid L1 filled between the lens 132 and the parallel plate 134, and a liquid L2 filled between the parallel plate 134 and the wafer 140. The liquid L1 may be the same as the liquid L2 and may be different from the liquid L2. Peripheries of the liquid L1 and the liquid L2 are retained by an air curtain (not shown).

The liquid supply and recovery mechanism 150A includes a liquid supply and recovery mechanism for the liquid L1 and a liquid supply and recovery mechanism for the liquid L2. The liquid supply and recovery mechanism for the liquid L1 includes a cover 151, a couple of supply nozzles 152a, and a couple of recovery nozzles 154a. The liquid supply and recovery mechanism for the liquid L2 includes a cover 151, a couple of supply nozzles 152b, and a couple of recovery nozzles 154b. The cover 151 may be coupled to the lens barrel of the projection optical system 130 and may not be coupled to the lens barrel of the projection optical system 130. In other words, the cover 151 may be a part of the projection optical system 130 and may be another member. Similar to the first embodiment, the supply nozzles 152a and 152b are a part of the liquid supply system, and the recovery nozzles 154a and 154b are a part of the liquid recovery system.

In the instant embodiment, the surface of the liquid-holding board 144 is processed so that the contact angle of the parallel plate 134 is equal to or smaller than the contact angle of the wafer 140 and the contact angle of the wafer 140 is equal to or smaller than the contact angle of the liquid-holding board 144. The material of the surface treatment can apply the same material as that in the first embodiment. Thereby, the instant embodiment can prevent the defective exposure.

In exposure, the light from the light source section enters the illumination optical system 110, and the illumination optical system 110 uniformly illuminates the reticle 120. The projection optical system 130 reduces at a predetermined magnification and projects onto the wafer 140 the light that passes the reticle 120. The exposure apparatus 100 is the scanner, fixes the projection optical system 130, and synchronously scans the reticle 120 and the wafer 140 to expose the entire shot. Then, the wafer stage 142 is stepped to the next shot for a new scan operation. This scan and step are repeated, and many shots are exposed on the wafer 140.

Since the final surface of the projection optical system 130 at the side of the wafer 140 is immersed in the liquid L that has a refractive index higher than that of the air, the projection optical system 130 has a higher NA and provides a higher resolution on the wafer 140. The liquid L exists between the projection optical system 130 and the wafer 140, and moves with the movement of the wafer 140. At this time, the liquid L does not remain in the liquid-holding board 144 or another shot on the wafer 140, and is not dragged. Therefore, the exposure apparatus 100 can prevent the mix of the air bubbles and generation of turbulence by a shortage of the liquid L between the projection optical system 130 and the wafer 140. Thereby, the exposure apparatus 100 transfers the pattern to the resist with high precision, and provides a high-quality device, such as a semiconductor device, an LCD device, an image pick-up device (e.g., a CCD), and a thin-film magnetic head.

### Fourth Embodiment

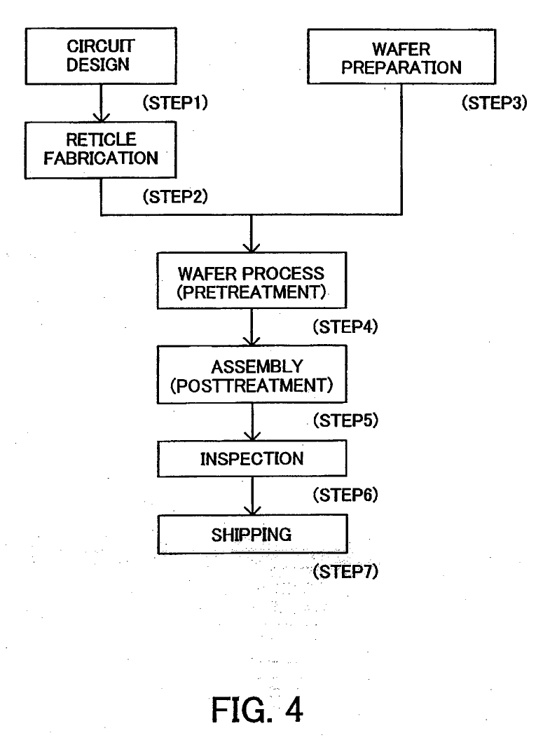

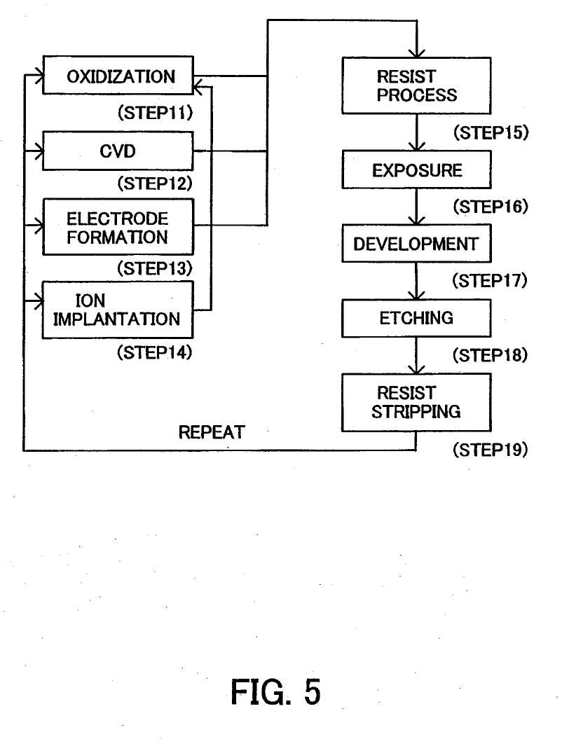

Referring now to FIGS. 4 and 5, a description will be given of an embodiment of a device fabrication method using the exposure apparatus 100 mentioned above. FIG. 4 is a flowchart for explaining how to fabricate devices (i.e., semiconductor chips, such as ICs and LSIs, LCDs, CCDs, and the like). Here, a description will be given of the fabrication of a semiconductor chip as an example. Step 1 (circuit design) designs a semiconductor device circuit. Step 2 (reticle fabrication) forms a reticle having a designed circuit pattern. Step 3 (wafer preparation) manufactures a wafer using materials such as silicon. Step 4 (wafer process), which is also referred to as a pretreatment, forms the actual circuitry on the wafer through lithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 5 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition, and the like. Step 14 (ion implantation) implants ions into the wafer. Step 15 (resist process) applies a photosensitive material onto the wafer. Step 16 (exposure) uses the exposure apparatus 100 to expose a circuit pattern of the reticle onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device fabrication method of this embodiment may manufacture higher quality devices than the conventional one. Thus, the device fabrication method using the exposure apparatus 100, and resultant devices, constitute one aspect of the present invention.

Furthermore, the present invention is not limited to these preferred embodiments and various variations and modifications may be made without departing from the scope of the present invention.

This application claims benefit of foreign priority based on Japanese Patent Applications No. 2005-054814, filed on Feb. 28, 2005, and No. 2006-026249, filed on Feb. 2, 2006, each of which is hereby incorporated by reference herein in its entirety as if fully set forth herein.

What is claimed is:

1. An exposure apparatus comprising:
a projection optical system for projecting a pattern of a reticle onto an object to be exposed, via a liquid that is filled in a space between a final optical element in said projection optical system and the object; and
a liquid-holding member provided around the object and having a surface that is as high as a surface of the object, said liquid-holding member for retaining the liquid,
wherein said surface of the liquid-holding member is processed so that a first contact angle between the liquid and the surface of the object is equal to or smaller than a second contact angle between the liquid and the surface of the liquid-holding member.

2. An exposure apparatus according to claim 1, wherein a third contact angle between the liquid and a surface of the final optical element in the projection optical system is equal to or smaller than the first contact angle.

3. An exposure apparatus according to claim 1, wherein said second contact angle is 90° or more.

4. An exposure apparatus according to claim 2, wherein said third contact angle is less than 60°.

5. An exposure apparatus according to claim 2, further comprising a liquid supply and recovery mechanism for supplying and recovering the liquid,
wherein a fourth contact angle between the liquid and a periphery of a liquid contacting portion in the liquid supply and recovery mechanism is equal to or greater than the third contact angle.

6. An exposure apparatus according to claim 2, further comprising a liquid supply and recovery mechanism for supplying and recovering the liquid,
wherein a fourth contact angle between the liquid and a periphery of the liquid supply and recovery mechanism, which periphery inclines relative to the object or the liquid-holding member is equal to or greater than the third contact angle.

7. An exposure apparatus according to claim 5, wherein said fourth contact angle is 90° or more.

8. An exposure apparatus comprising:
a projection optical system for projecting a pattern of a reticle onto an object to be exposed, via a liquid that is filled in a space between a final optical element in said projection optical system and the object; and
a liquid-holding member provided around the object and having a surface that is as high as a surface of the object, said liquid-holding member for retaining the liquid,
wherein said surface of the liquid-holding member is processed so that a first receding contact angle between the liquid and the surface of the object is equal to or smaller than a second receding contact angle between the liquid and the surface of the liquid-holding member.

9. An exposure apparatus according to claim 8, wherein said second receding contact angle is 90° or more.

10. A device fabrication method comprising the steps of:
exposing an object to be exposed using an exposure apparatus according to claim 1; and
performing a development process for the object exposed.

11. A device fabrication method comprising the steps of:
exposing an object to be exposed using an exposure apparatus according to claim 8; and
performing a development process for the object exposed.
